(19) United States
(12) Patent Application Publication
(10) Pub. No.: US 2016/0331014 A1
(43) Pub. Date: Nov. 17, 2016

(54) PROTEIN FOOD PRODUCT COMPRISING D-ALLULOSE

(71) Applicant: ROQUETTE FRERES, Lestrem (FR)

(72) Inventor: Chandani PERERA, Batavia, IL (US)

(21) Appl. No.: 15/106,346

(22) PCT Filed: Dec. 20, 2013
(86) PCT No.: PCT/US2013/076932

§ 371 Date: Jun. 20, 2016

(51) Int. Cl. A23L 29/30; A23L 27/30; A23L 33/19; A23L 33/185

(52) U.S. Cl. CPC A23L 29/30; A23L 33/185; A23L 27/33; A23L 33/19; A23V 2002/00

(57) ABSTRACT

Disclosed is a solid food product including a D-allulose syrup and a native protein. Also disclosed is the use of this solid food product as a protein supplement for dietarians, athletes and bodybuilders. It also relates to use of D-allulose to reduce hardening of a protein food product, as an aid for quick hydration and as an aid for improving the cohesiveness of a dough.

### FIELD OF THE INVENTION

The present invention pertains to a solid food product comprising a D-allulose syrup and a native protein. This invention is also directed to the use of this solid food product as a protein supplement for dietarians, athletes and bodybuilders. This invention also pertains to the uses of D-allulose to reduce hardening of a protein food product, as an aid for quick hydration and as an aid for improving the cohesiveness of a dough.

### BACKGROUND OF THE INVENTION

High protein dough bars are currently available on the market, which generally include native, non-modified proteins with traditional sweeteners usually in the form of syrups, such as glucose syrups. These dough bars are popular among individuals who are on a diet or seek nutritional supplements for sports or bodybuilding.

It has been shown that traditional sweeteners, i.e. glucose syrups, have a slow hydration rate, which increases the manufacturing time of the dough made therefrom. Moreover, the dough has a reduced cohesiveness, which makes it adhere to the sides of the mixing bowl used to produce it. This inconvenience also increases the manufacturing time and negatively affects the yield of the process.

Other disadvantages of traditional bar formulations are linked to the proteins contained therein. It has been observed that these bars tend to harden during storage, which reduces their shelf life. This phenomenon comes from the evaporation with time of the water initially absorbed by the protein from the syrup. Drying of the protein results in increased toughness and hardness of the whole bar. In order to overcome this problem, two main solutions have been proposed. The first one consists in adding glycerine to the bar formulation in order to prevent water migration. However, glycerine results in flavour modification which is not acceptable. Another solution which has been suggested, for instance, in U.S. Pat. No. 7,399,496, consists in the substitution of protein hydrolysates for native proteins. Protein hydrolysates indeed open up the protein molecule to expose more hydrophilic side chains to water during processing, which thus prevents water migration and then hardening of the dough bars over time during storage. Moreover, these hydrolysates also have a faster hydration rate, which improves their mixing with the other ingredients of a dough bar and thus the productivity of the manufacturing process.

Although they provide some benefits, protein hydrolysates are not always well perceived by consumers, which are more and more reluctant to use modified raw materials and would rather turn to more “natural” food ingredients. Moreover, protein hydrolysates may lead to bars that are too soft to be extruded. Therefore, it would be advantageous to provide another solution to the problems of fast hardening of dough bars containing native proteins.

After extensive research, it has been shown that the use of a specific binder based on D-allulose allows formulating high-protein dough bars containing native proteins, which have an acceptable hardness when just manufactured and do not become excessively hard over time. Interestingly, D-allulose also provides a fast hydration rate which speeds up the manufacture of the dough bar, as well as improved cohesiveness.

D-allulose, also called D-psicose, is a C-3 epimer of D-fructose, which belongs to “rare sugars”. It has 70% of the relative sweetness of sucrose but a caloric value of 0.007 Kcal/g only. It was allowed as a food ingredient by the FDA in 2011. Due to its sweetness, and to the fact that it has only 0.3% of the calorific value of sucrose, it has been suggested as an ideal sucrose substitute for food products. At the opposite of fructose, when ingested by humans, allulose is partly absorbed and metabolized into energy, and partly excreted unchanged in the urine and in the faeces.

The characteristics of D-allulose as a material for preventing lifestyle-related diseases have been disclosed, including its low-caloric nature, a positive effect on the reduction of the glycemic response, an antiobesity effect, and the like. It can also be used as an inhibitor of hepatic lipogenic enzyme and intestinal α-glycosidase for reducing body fat accumulation. It further shows important physiological functions, such as reactive oxygen species scavenging activity and neuroprotective effect.

D-allulose can be produced from D-fructose by D-tagatose 3-epimerase (DTEase) family enzymes which have been found in various micro-organisms. This interconversion has been regarded as an attractive way to produce D-allulose.

However, to the inventors' knowledge, it has not been suggested to use D-allulose as a binder in the manufacture of protein food products such as high-protein dough bars.

### SUMMARY OF THE INVENTION

The present invention pertains to a solid food product comprising a D-allulose syrup and a native protein.

This invention is also directed to the use of this solid food product as a protein supplement for dietarians, athletes and bodybuilders.

This invention also pertains to the uses of D-allulose, respectively:
to reduce hardening of a protein food product containing at least one native protein,
in a mixture of dry ingredients comprising at least one native protein, as an aid for quick hydration of said dry ingredients, and
in the composition of a dough comprising at least one native protein, as an aid for improving the cohesiveness of said dough.

### DETAILED DESCRIPTION OF THE INVENTION

The solid food product of this invention may be a dough bar, a biscuit, a cookie or any other bakery good, preferably a dough bar.

This food product comprises a D-allulose syrup which consists in a concentrated solution of D-allulose and fructose and optionally other sugars in water, wherein D-allulose preferably represents from 50 to 98 wt. % and fructose represents from 2 to 45 wt. %, of the dry matter content of the syrup. This syrup may also include minor amounts (i.e. at most 40 wt. %) of glucose and/or other rare sugars such as mannose and allose, provided that the total amount of all the constituents of the syrup amounts to 100% by weight.

According to a preferred embodiment, this syrup comprises from 55 to 95 wt. % of D-allulose and from 5 to 45 wt. % of fructose, more preferably from 85 to 94 wt. % of D-allulose and from 6 to 15 wt. % of fructose, based on the dry matter content of the syrup. It may have a dry matter content of between 75 and 85 wt. %, preferably from 75 to 80%.

According to the invention, the D-allulose syrup may be prepared by a conventional process, namely through the epimerization of D-fructose at C-3 catalyzed by an enzyme of the D-tagatose 3-epimerase family (DTEase, EC 5.1.3.-), which is a commercially attractive enzymatic reaction for D-allulose production. To date, five DTEases from different organisms have been characterized and employed for D-allulose synthesis. They are commercially available. A putative DTEase from Agrobacterium tumefaciens can also be used, and due to its high substrate specificity towards D-allulose, this enzyme was renamed as D-allulose (D-psicose) 3-epimerase (DPEase, EC 5.1.3.-). In a preferred embodiment, the D-psicose 3-epimerase is selected from a D-tagatose 3-epimerase from Pseudomonas cichorii, a D-psicose 3-epimerase from Agrobacterium tumefaciens, a D-psicose 3-epimerase from Clostridium sp, a D-psicose 3-epimerase from Clostridium scindens, a D-psicose 3-epimerase from Clostridium bolteae, a D-psicose 3-epimerase from Ruminococcus sp, and a D-psicose 3-epimerase from Clostridium 20 cellulolyticum. In a preferred embodiment, the parent D-psicose 3-epimerase is a D-psicose 3-epimerase from Clostridium cellulolyticum, more particularly Clostridium cellulolyticum strain H10 (ATCC 35319).

The raw material used for the epimerization may be crystalline fructose with a purity about 99%, for instance. This raw material may then be diluted with water to about 45% dry substance before the syrup is allowed to react with en epimerization enzyme (DTEase or DPEase), for instance at 55.0° C. and at a pH of 7.0. The reaction may be allowed to proceed for about 40 hours before collecting the syrup. The resulting allulose syrup may then be passed through microfiltration to remove insoluble cell mass of enzyme, then subjected to carbon filtration to remove its color, and then to a demineralization step on an ion exchange column to further remove minerals and other impurities. The syrup can then be concentrated using a conventional evaporator. This allulose syrup may further be subjected to an enrichment step by passing it through a chromatographic simulated moving bed (SMB) with a calcium ion exchange resin.

The D-allulose syrup may represent from 15 to 60 wt. % of the food product.

The food product of this invention also includes a native protein. The term “native protein” employed in the context of this invention refers to a protein concentrate or isolate which has not undergone any chemical or enzymatic treatment, such as hydrolysis. Native proteins may be obtained by defatting and removing most or all of the carbohydrates contained in a protein source. They include vegetable proteins, milk (including whey) proteins and their mixtures. Vegetable proteins may be selected from pea, wheat, corn, soy and potato proteins and their mixtures. Examples of native proteins are available from ROQUETTE FRERES under the trade names Nutralys®, Viten®, Glutalys® and Tubermine®. The protein may represent from 15 to 45 wt. % of the food product, based on its dry matter content.

The food product of this invention may also contain various additives including, for instance, nuts such as almonds, peanuts, walnuts; fruits; chocolate; cocoa butter; emulsifiers such as lecithin; dietary fibers; vegetable oils; salt; sweeteners such as glucose and/or fructose syrups, Stevia, sucralose; flavours such as vanilla; colouring agents; vitamins; minerals; and their mixtures.

Preferably, this food product does not include any hydrolysed protein.

It has been demonstrated that this food product may have a hardness between 900 and 400 g, preferably between 100 and 300 g, immediately after manufacture, as measured using a TA HD Plus Texture Analyzer supplied by Texture Technologies Corporation, with a 5 kg load cell and a 4 mm probe, according to the method described by Stable MicroSystems under Reference CHOC2/P4. Moreover, the hardness of this product does not increase of more than 500%, preferably of more than 400% and even more preferably of more than 300%, after 1.5 month of storage at room temperature (20° C.±2° C.)

Moreover, the D-allulose syrup also provides for at least two other benefits. First, in the mixture of dry ingredients comprising the native protein, it acts as an aid for quick hydration of said dry ingredients. By “quick hydration”, it is meant that a 300 g batch of dough becomes hydrated in at most 1 minute. This is advantageous from the view point of the manufacturing time necessary to prepare the food product according to this invention. Second, the D-allulose syrup also acts as an aid for improving the cohesiveness of the dough, i.e. reduce its sticking to the sides of the mixing bowl, which results in a higher efficiency and a better yield of the manufacturing process.

### Examples

This invention will be further illustrated by the following non-limiting examples which are given for illustrative purposes only and should not restrict the scope of the appended claims.

### Example 1

### Manufacture of Dough Bars

Dough bars were prepared from various sweeteners, namely a D-allulose syrup according to this invention and various glucose and/or fructose syrups, by mixing the dry ingredients of Table 1 below in a kitchen aid mixer bowl, then adding the syrup at 75° C. with canola oil to the dry blend and mixing the ingredients until a smooth ball was obtained. Each of the dough balls was then sheeted and cut into pieces when cooled down to room temperature.

TABLE 1

| | | | | | 63DE + |
|---|---|---|---|---|---|
| | D- | | | POLY- | HiSweet |
| | allulose | HiSweet | LYCASIN | SORB | 42 |
| Ingredient | syrup | 55 | 80-55 | 75/67 | (50:50) |
| Pea protein | 18.2 | 18.2 | 18.2 | 18.2 | 18.2 |
| PowerProtein | 18.2 | 18.2 | 18.2 | 18.2 | 18.2 |
| 515 WPC | | | | | |
| NUTRIOSE FM | 7.3 | 7.3 | 7.3 | 7.3 | 7.3 |
| 06 | | | | | |
| Syrup | 54.5 | 54.5 | 54.5 | 54.5 | 54.5 |
| Canola oil | 1.8 | 1.8 | 1.8 | 1.8 | 1.8 |
| Total | 100.0 | 100 | 100 | 100 | 100.0 |

In the above table, the raw materials used have the following composition:

PowerProtein® 515 WPC (FONTERRA): whey protein concentrate
NUTRIOSE® FM 06 (ROQUETTE FRERES): soluble dextrin derived from corn starch
D-allulose syrup: syrup with 82 wt. % dry matter and containing 55 wt. % of allulose and 45 wt. % of fructose
HiSweet® 55 (ROQUETTE AMERICA) : high fructose corn syrup containing 55 wt. % of fructose and 42 wt. % of glucose
LYCASIN® 80-55 (ROQUETTE FRERES): maltitol syrup with 55 wt. % of maltitol
POLYSORB® 75/65 (ROQUETTE AMERICA): maltitol syrup with 67 wt. % of maltitol and 4% sorbitol (dry basis) with 75% ds
Roquette glucose syrup 6384 63 DE (ROQUETTE AMERICA): corn syrup
HiSweet® 42 (ROQUETTE AMERICA): high fructose corn syrup containing 42 wt. % of fructose and 53 wt. % of glucose

### Example 2

### Texture Analysis

The dough bars of Example 1 were tested to assess their texture at various times after manufacture. For this purpose, their hardness was measured using a TA HD Plus Texture Analyzer supplied by Texture Technologies Corporation, with a 5 kg load cell and a 4 mm probe, according to the method described by Stable MicroSystems under Reference CHOC2/P4. The results of this test are reported in Table 2 below.

TABLE 2

| | | | | | 63DE + |
|---|---|---|---|---|---|
| | D- | | | | HiSweet |
| | allulose | HiSweet | LYCASIN | POLYSORB | 42 |
| Hardness (g) | syrup | 55 | 80-55 | 75/67 | (50:50) |
| Day 1 | 134 | 43 | 80 | 52 | 92 |
| Day 7 | 328 | 150 | 110 | 91 | 206 |
| Month 1.5 | 521 | 611 | 307 | 250 | 665 |

As evident from this table, only the dough bars made from the composition of this invention provided both enough hardness (i.e. more than 90 g) after manufacture and a slow hardening (i.e. less than 300%) over 1.5 months.

Moreover, it was observed that the dough bars made from D-allulose syrup were not sticky immediately after manufacture, contrary to the other bars. They were thus easier to mould. Furthermore, the D-allulose syrup hydrated the dry ingredients much more easily, contrary to the other syrups. The time necessary to make the dough bars (i.e. time elapsed between the incorporation of the syrup and the effective dispersion thereof among the dry ingredients) was thus reduced to 1 min, whereas it ranged from 2 minutes (HiSweet® 55 and Polysorb® 75/65) to 4 minutes (Lycasin® 80-55) for the other dough bars. Finally, the dough obtained according to this invention had a smooth and uniform texture. It also appeared to be more cohesive than the dough obtained with any other syrup, which tended to form a more or less uniform ball with pieces of dough adhering to the bowl. The slightly firm texture of the ball obtained with this invention also allowed it to retain its shape after wetting, which was not the case of balls produced from HiSweet® 55 and Polysorb® 75/65, for instance.

1. Solid food product comprising a D-allulose syrup and a native protein.

2. Solid food product according to claim 1, comprising from 15 to 45 wt. % of native protein.

3. Solid food product according to claim 1, wherein the D-allulose syrup consists in a concentrated solution of D-allulose and fructose, wherein D-allulose represents from 50 to 98 wt. %, fructose represents from 2 to 45 wt. %, of the dry matter content of the syrup.

4. Solid food product according to claim 1, wherein the D-allulose syrup represents from 15 to 60 wt. % of the food product, based on the total weight of the food product.

5. Solid food product according to claim 1, wherein the syrup comprises from 55 to 95 wt. % of D-allulose and from 5 to 45 wt. % of fructose, based on the dry matter content of the syrup.

6. Solid food product according to claim 1, wherein the native protein is selected from vegetable proteins, milk proteins, whey proteins, and their mixtures.

7. Solid food product according to claim 1, wherein the solid food product does not include any hydrolysed protein.

8. Solid food product according to claim 1, wherein the solid food product is selected from dough bar, a biscuit or a cookie.

9. A method for supplementing protein for dieticians, athletes, and bodybuilders, comprising supplying an effective amount of the solid food product according to claim 1.

10. A method for reducing hardening of a protein food product containing at least one native protein, comprising adding an effective amount of D-allulose.

11. A method for aiding quick hydration of a mixture of dry ingredients comprising at least one native protein, comprising adding an effective amount of D-allulose syrup.

12. A method for improving the cohesiveness of a dough comprising at least one native protein, comprising adding an effective amount of D-allulose syrup.

13. Solid food product according to claim 2, wherein the D-allulose syrup consists in a concentrated solution of D-allulose and fructose, wherein D-allulose represents from 50 to 98 wt. %, fructose represents from 2 to 45 wt. %, of the dry matter content of the syrup.

14. Solid food product according to claim 2, wherein the D-allulose syrup represents from 15 to 60 wt. % of the food product, based on the total weight of the food product.

15. Solid food product according to claim 3, wherein the D-allulose syrup represents from 15 to 60 wt. % of the food product, based on the total weight of the food product.

16. Solid food product according to claim 2, wherein the syrup comprises from 55 to 95 wt. % of D-allulose and from 5 to 45 wt. % of fructose, based on the dry matter content of the syrup.

17. Solid food product according to claim 3, wherein the syrup comprises from 55 to 95 wt. % of D-allulose and from 5 to 45 wt. % of fructose, based on the dry matter content of the syrup.

18. Solid food product according to claim 4, wherein the syrup comprises from 55 to 95 wt. % of D-allulose and from 5 to 45 wt. % of fructose, based on the dry matter content of the syrup.

19. Solid food product according to claim 1, wherein the native protein is selected from vegetable proteins, milk proteins, whey proteins, and their mixtures.

20. Solid food product according to claim 2, wherein the native protein is selected from vegetable proteins, milk proteins, whey proteins, and their mixtures.
